(19) United States
(12) Patent Application Publication
(10) Pub. No.: US 2005/0010546 A1
(43) Pub. Date: Jan. 13, 2005

(54) System and method for determining product specification limits

(75) Inventors: Edward D. Nowotny, Austin, TX (US); Snehanshu Shah, Austin, TX (US); William Miller, Phoenix, AZ (US); Thomas Martis, Chandler, AZ (US)

Correspondence Address: DONALD J. LENKSZUS, PO BOX 3064, CAREFREE, AZ, 85377-3064, US

(73) Assignee: SIVERION, INC., Tempe, AZ (US)

(21) Appl. No.: 10/615,418

(22) Filed: Jul. 7, 2003

(51) Int. Cl. G06F 17/30

(52) U.S. Cl. 707/1

(57) ABSTRACT

A system and method in accordance with the present invention determines optimal specification limits for product by utilizing the characterization values for parameters of a plurality of known good parts. The known good parts are proportioned based upon a desired yield. The proportioned known good parts are partitioned into to provide a subset. The parameters of the partitioned subset of known good parts are utilized to determine the specification limits of the product.

### RELATED APPLICATIONS

The present invention is advantageously utilized with the system described in co-pending patent application Ser. No. ______ filed on Oct. 22, 2002, titled SEMICONDUCTOR CHARACTERIZATION AND PRODUCTION INFORMATION SYSTEM and which is an improvement over co-pending patent application Ser. No. 09/896,170 filed Jun. 29, 2001, which was published on Jan. 3, 2002 as Patent Publication No. 2002/0002560 and which claims priority based upon provisional application for patent 60/215,490 filed Jun. 30, 2000. All of the prior applications are assigned to a common assignee of the present application. The disclosures of those prior applications are incorporated herein by reference.

### FIELD OF THE INVENTION

This invention relates generally to systems and methods for determining product specification limits for products, and to a system and method for determining product specification limits within a semiconductor manufacturing fabrication environment, in particular.

### BACKGROUND OF THE INVENTION

Semiconductor device manufacturing is fast becoming disaggregated as companies focus on core competencies and contract out all other work. The result is the proliferation of so-called “fabless” semiconductor manufacturers.

In many instances, fabless semiconductor companies have their operations and data spread across a global supply chain. By way of example, a fabless company may design a chip with engineers located in California, have the wafers (each consisting of many devices) fabricated in Taiwan, have wafer testing occur in Taiwan, yet have assembly of the device occur in Malaysia and the characterization and qualification occur in California. To meet short market windows of opportunity, a fabless semiconductor company's information systems must support rapid decision-making. Otherwise, yield loss at any node in the supply chain causes a loss of revenue and increased work in progress material.

Fabless semiconductor companies face a number of challenges in getting product to market in a timely manner. Moving new components out of design, into prototypes and finally into production to meet a market window is critical to success. If engineering productivity does not keep pace with design and manufacturing complexities, the result is lost opportunities. Tracking quality to optimize yield is more important and proportionately more difficult across the distributed supply chain of a fabless manufacturer. Compounding the difficulty is a rapidly shrinking product life cycle that makes timely sharing of semiconductor data across remote locations in a timely manner even more critical.

In the past, when a product is outsourced for an individual operation, and is returned to the processing facility, a hard table or printout of the data associated with that operation is typically returned with the product. Similarly, a semiconductor device completed at the fabrication facility may be shipped to an assembly facility where it is actually bonded to external wires and packaged. It would be desirable to be able to integrate this data with the data from the processing facility to have a better understanding of failure mechanisms within the device.

It is desirable to provide a means that will help product engineers identify and act quickly on chip manufacturing issues so that designs may move quickly from concept to final product in the shortest amount of time and in an economically viable way.

Once product has been designed and fabricated, it is important to determine optimal specification limits for the product. The determination is a significant problem because there may be hundreds of parameters per part. In addition, each parameter must be measured under multiple conditions such as at different temperatures, different frequencies, different ac and dc voltage levels and other conditions.

In the past, engineers would generate characteristic plots for each parameter under different conditions. The plots would be obtained by monitoring a specific parameter and then varying all of the input conditions. By viewing several plots, the engineers would make a determination of what the product specification limits should be to obtain specific production yields. By viewing the plots, the engineers can determine what issues exist with respect to the part's performance. Once the issues are identified, the engineers determine what specification limit tradeoffs can be made to obtain the best yield.

This process is performed manually and requires a lot of churning of data utilizing such conventional software tools as spreadsheet computer programs.

### SUMMARY OF THE INVENTION

In accordance with the principles of the invention, a system and method are provided that permits product engineers to determine optimal limits for products by using characterization data. These limits are then used to create the product specifications. In a system in accordance with the principles of the invention, an interactive system is utilized to determine the specification limits.

A system in accordance with the present invention provides characterization and production monitoring information for semiconductor products and utilizes the characterization and monitoring information to determine product specification limits for production products.

In accordance with the principles of the invention a characterization methodology is utilized in which a system tests all parts and loads all test data into a database. The system automatically determines the data set to analyze. The system creates all operation condition permutations and then identifies any part or part and variable combination for which there are missing data values. The system also, identifies any measurements that are out-of-bounds. The system identifies failing parameters and failing parts. The system of the invention determines if there is a particular operating condition or manufacturing condition that causes a parameter to be out of specification by utilizing statistical analysis of variance and regression. The system models the sensitivity of each parameter to different operating conditions by utilizing an analysis of variance algorithm.

Still further in accordance with the principles of the invention, the system determines for each parameter which, if any, parts behave differently from other parts by use of an algorithm.

In accordance with the principles of the invention, characterization data for products in accordance with a first algorithm is obtained from a database. A plurality of known good parts is identified from the characterization data. The user selects a set of parameters for specification limits are desired. For each selected parameter a determination is made as to which of upper, lower, or upper and lower specification limits are to be obtained. In addition, a proportion of said set of known good one of said product to be used to determine product specification limits is specified. The system of the invention determines whether a sufficient number of the identified known good parts have minimum and maximum test measurement data that are respectively above and below predetermined lower and upper product specification limits. The plurality of known good parts is then partitioned into two subsets; a first one of the two subsets contains a sufficient number of ones of the plurality of known good parts that at least meet the specified proportion. Characterization data for the first subset is utilized to determine said specification limits.

In accordance with another aspect of the invention, partitioning of the plurality of known good parts is achieved by utilizing a predetermined algorithm.

Still further in accordance with the principles of the invention, the partitioning of the plurality is achieved by utilizing a scoring algorithm.

In one embodiment of the invention the scoring algorithm is an aggregate variability algorithm wherein a score is computed for every known good part. The score represents the aggregate variability of all parameters for each part. The score is a number that can be used to sort all the known good parts in a rank order from least aggregate variability to most. Once sorted, a sufficient number of parts is selected to satisfy the requested proportion.

In the aggregate variability algorithm utilized in the illustrative embodiment of the invention, the mean for each parameter is selected. The magnitude of variation is determined by selecting the greater of the difference of the minimum and maximum test measurement values from the mean of the part. A parameter score is then computed.

In another embodiment of the invention a margin bound algorithm is utilized.

In accordance with another aspect of the invention, “what-if” analysis of products is provided.

In accordance with another aspect of the invention, a user can change a production target yield to determine the impact on the parameter limits or vice versa.

### BRIEF DESCRIPTION OF THE DRAWING

The invention will be better understood from a reading of the following detailed description taken in conjunction with the accompanying drawing figures in which like reference numbers indicate like features and wherein:

FIG. 1 is a diagram illustrating a semiconductor product life cycle;

FIG. 2 illustrates semiconductor manufacturing flow with data types;

FIG. 3 illustrates a packaged semiconductor part to which the system and method of the present invention is advantageously applied;

FIG. 4 is a block diagram of a system in accordance with the invention;

FIG. 5 is a platform diagram of the system of the invention;

FIG. 6 illustrates a characterization data selection hierarchy; and

FIGS. 7 through 12 are flow diagrams in accordance with the principles of the invention.

### DETAILED DESCRIPTION

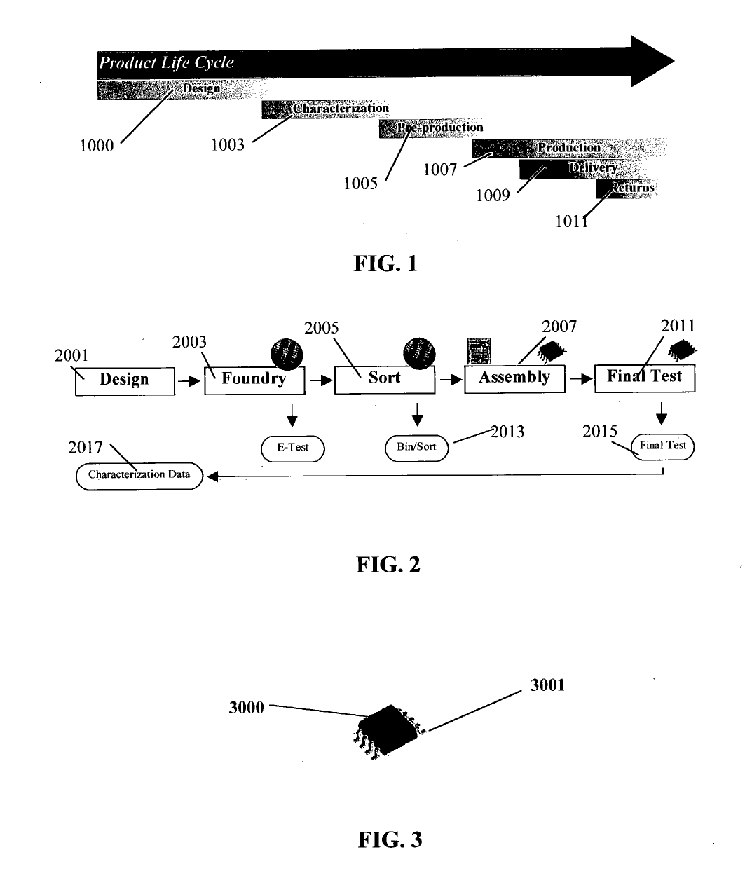

The success of a fabless company is largely determined by how quickly it can deliver a yielding product to market. The product lifecycle typically involves design 1001, characterization 1003, pre-production 1005, production 1007 and delivery 1009 as shown in FIG. 1. Device characterization takes place early in a product's life cycle preceding high-volume manufacturing to verify its performance to specifications and manufacturability. Device characterization is performed to insure that a part functions over the complete operating range (e.g., ambient temperature, power supply voltages, clock frequency, etc.) specified for the product. The present invention utilizes a characterization module to help design and product engineers manage, visualize, and analyze the massive amount of data typically crated to support verification of a device.

The characterization 1003 and pre-production 1005 phases of a product life cycle can last from 3-6 months and are necessary to determine if a device can be manufactured profitably. The analysis performed during this time allows a company to quantify the tradeoff between manufacturing yield and performance which sets target yields, number of WIP starts, and necessary inventory levels.

There are three important outcomes of characterization testing 1003: First, the design is verified over all combinations of the operating conditions it may encounter once placed into operation. This testing helps identify design issues and develop insight into a device's dependencies on voltage, temperature, and frequency. Second, manufacturing variability can have a significant impact on device performance. Testing is performed over a range of guaranteed manufacturing process settings to reveal how yield changes as key performance metrics of the manufacturing process drift within the guaranteed range. Finally, as a consequence of the first two outcomes, characterization testing validates the production test program and helps determine production test limits, which are the pass/fail limits used in production testing. Each these outcomes are typically achieved from the same small number of lots of data collected at final test.

FIG. 2 is a high-level view of the flow of a product through design 2001, manufacturing 2003, sort 2005, assembly 2007, and final test 2011.

During normal production, data collected at final test 2011 is largely dominated by pass/fail information. Once test limits are established, the primary interest is if a part passes or fails a particular test. The objective is to pass or fail the part as quickly as possible. For device characterization, higher levels of detail are collected for each test applied to the part. To support characterization analysis the platform of the present invention loads a wide range of data types, including parametric measurements, test limit values, and test conditions.

A “part” 3000 is a packaged die as shown in FIG. 3; which is the actual product sold. Each part 3000 may have any where from 3 to 400 or more pins 3001.

A “pin” 3001 is the electrical connection point for the part to a circuit board.

A “test” determines a part's measured output to a specific input, A test may apply at the pin level or at the part level. The output is compared to a test limit and the part either passes or fails.

A “test condition” refers to the environment a part is subjected to when it is tested. Typical conditions include power supply voltage (e.g., Vcc measured over a range in volts), frequency (e.g., clock frequency measured over a range in Hz), and temperature (e.g., temperature measured over a range in ° C.).

Conditions may also refer to the manufacturing environment. To develop insight into the effect of manufacturing variation, fabrication experiments may be performed on characterization lots to explore how parts behave when fabricated within the bounds of the normal process variations expected during manufacturing.

The present invention provides a comprehensive data management, reporting and collaboration system for determining product specification limits. The system of the present invention may be Internet or world-wide web based so that users around the world can access data and collaborate on solutions in real time, or it can be network based on a local area network LAN or wide area network WAN to permit use in an integrated facility or with a proprietary network between several locations.

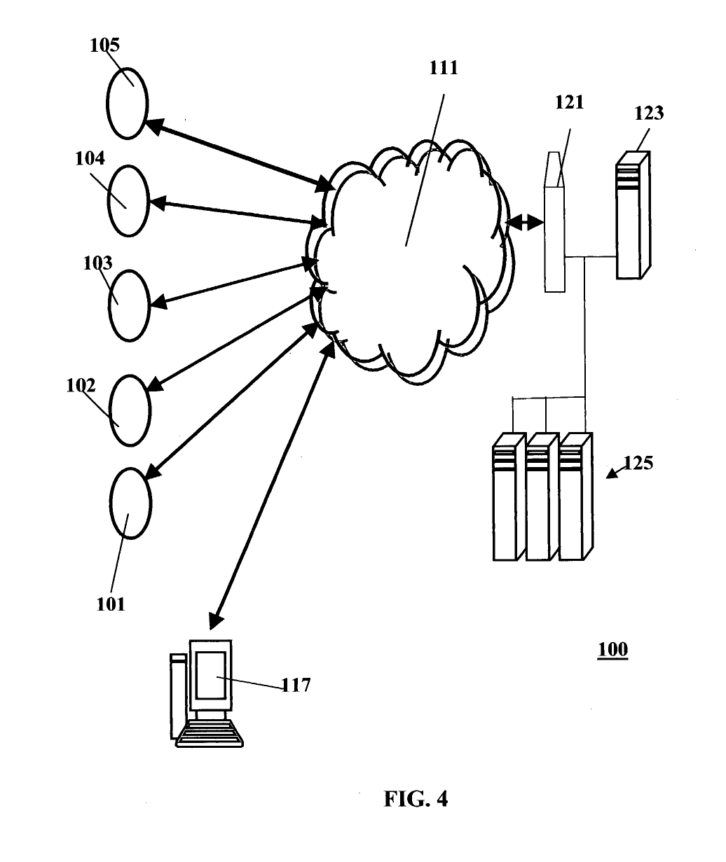

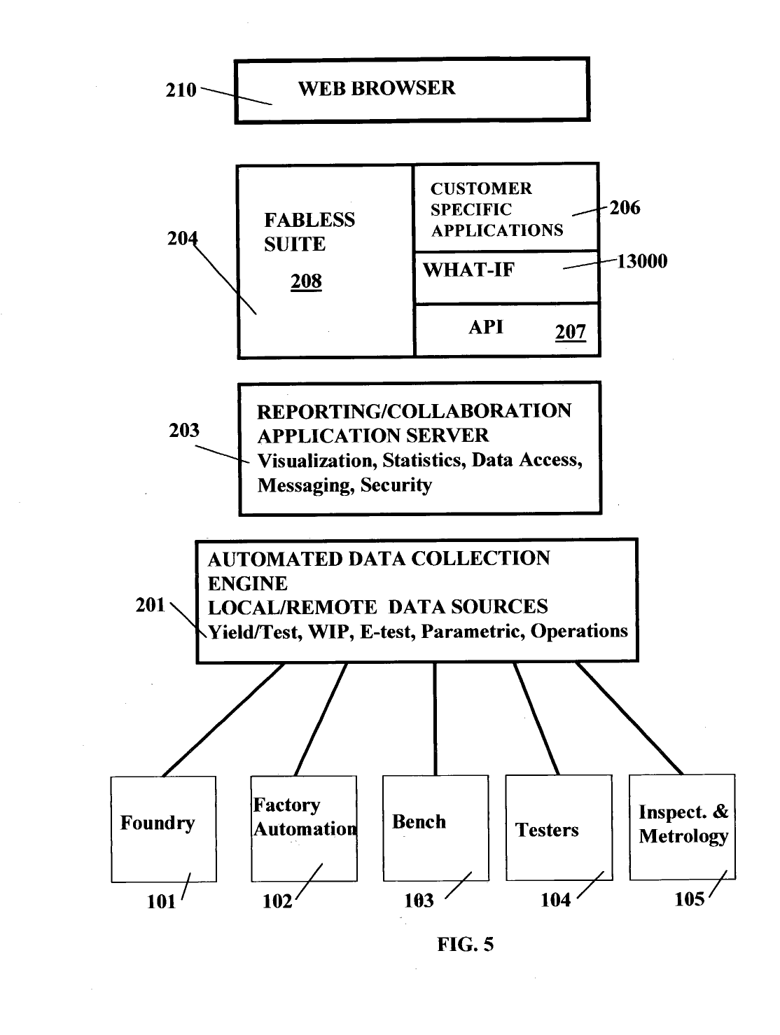

Turning now to FIG. 4, the system 100 of the present invention is shown. System 100 includes a server 123 and a database 125 coupled to firewall 121. Although only one server is shown, it will be understood by those skilled in the art that one or more physical servers may be used to provide server 123. Server 123 may be a commercially available server. Database 125 may similarly comprise a plurality of physical databases, all of which are accessible via server 123. Database 125 may be accessed via server 123. Server 123 is coupled to network 111 which, in the illustrative embodiment shown, is the worldwide web of computers commonly referred to as the Internet. Also coupled to Internet 111 are data sources 101, 102, 103, 104, 105. Various workstations or computer devices 117 are also coupleable to Internet 111. A firewall 121 is utilized to protect server 123 and database 125. Firewall 121 may be any commercially available firewall.

Turning now to FIG. 5, the various data sources 101, 102, 103, 104, 105 include a semiconductor foundry 101, factory automation computers 102, bench analyzers 103, various testers 104 and inspection and metrology devices 105. Each of the data sources 101, 102, 103, 104, 105 may be located locally with server 123 and database 125, or may be geographically remote therefrom. Each data source 101, 102, 103, 104, 105 provides either yield/test data, WIP data, e-test data, parametric data and/or operations data to Server 123.

Server 123 includes an automated data collection engine 201 to collect data from data sources 101, 102, 103, 104, 105. Engine 201 is provided with a URL or ftp site or directory (location of files) for each of the various sources 101, 102, 103, 104, 105. Additionally, an engineer or other user accessing the system and method of the present invention need only be provided with a URL through which they may interface via a portal to software engine 201 via server 123. The retrieved data is stored in database 125. Data collection is performed via Internet 111 by information exchanges between server 123 and data sources 101, 102, 103, 104, 105.

An engineer or other user of the system 100 of the invention may access database 125 utilizing a network accessing device 117 such as a computer or other device that may access the Internet 111.

Each device 117 in the illustrative embodiment includes a “web browser” 210 which may be a commercially available browser such as Internet Explorer or Netscape.

Server 123 hosts a platform 203 that provides a reporting/collaboration application server that provides visualization, statistics, data access, messaging and security. Platform 123 is structured as an N-tier, scalable platform. By way of example, platform 123 may employ Unix/Linux.

System 100 is capable of providing a large degree of reporting and analysis, but its basic function is to provide a consolidated view to a user via device 117. Server 123 integrates data and reports collected by engine 201 from data sources 101, 102, 103, 104, 105. Server 123 utilizing software platform 204 integrates selected data and reports in response to requests initiated at user device 117 and received via Internet 111. Server 123 outputs the integrated data and reports via Internet 111 to user device 117 for display to a user. This has the advantage of providing an engineer or operator or other decision-maker a unified, consistent user interface. Each user of system 100 accessing server 123 via Internet 111 does not need to worry about how the data is transferred from data sources 101, 102, 103, 104, 105 to Server 123 and database 125 since system 100 automatically obtains the data.

System 100 provides an interactive editor that enables users to utilize product characterization data obtained from database 125 to determine optimal specification limits for the product.

As described above, each user interacts with the system 100 from a workstation or other network access device or Internet device 117 using a standard web browser 210. The platform of system 100 does not require any specialized software to be installed at device 117 other than a commercially available web browser thereby advantageously reducing overall IT installation and support costs.

System 100 lets a user at device 117 “surf” live data interactively, moving freely between lot, wafer or die-level data while capturing key information or analysis at each step. The user does not need to know which data to “extract” before analyzing a problem. System 100 performs analysis directly against database 125, allowing a user at device 117 to modify a search in real time and to obtain answers more quickly. Users select data and then navigate and analyze data by clicking on data points or other features of interest displayed on a display included at device 117.

Server 123 also caches all analyses performed by users to enable all users to share the results with their team.

The suite of programs 204 includes a web content management and publication engine. The engine enables users to create custom reports for publication using the results of user-initiated analysis. In accordance with the principles of the invention, one such custom report is a specification sheet for a product. All published reports may be annotated by users and converted into a variety of formats, such as Adobe PDF, for publication.

The present invention provides an important advantage over prior art systems in that system 100 collects raw data and maintains relationships associated with the different raw data files. System 100 serves as a portal to allow data from many diverse data collection systems 101, 102, 103, 104, 105 to be seamlessly integrated into one user interface.

Data collection engine 201 automatically detects when new data has arrived. The configuration of the data collection source may determine whether or not this data is then in turn stored within a database or data file structure 125. When software engine 201 is coupled to a data source 101, 102, 103, 104, 105 engine 201 monitors the data source 101, 102, 103, 104, 105. If the data source is a database, the database is polled for data on a recurring basis. If the database is a file created by measurement equipment, then software engine 201 monitors and sets up directories for those type files and automatically loads the files into database 125. Engine 201 is network or web based. As such, it is completely platform independent and merely requires that user device 117 is operable on the network 111 used. Therefore, a user would be able to access data with appropriate permissions from any place in the world. This is particularly valuable for dispersed manufacturing systems where semiconductors may be produced at a foundry in a country such as Taiwan, tested in Hong Kong and ultimately assembled in the United States or where the engineers overseeing the process are located in a remote facility.

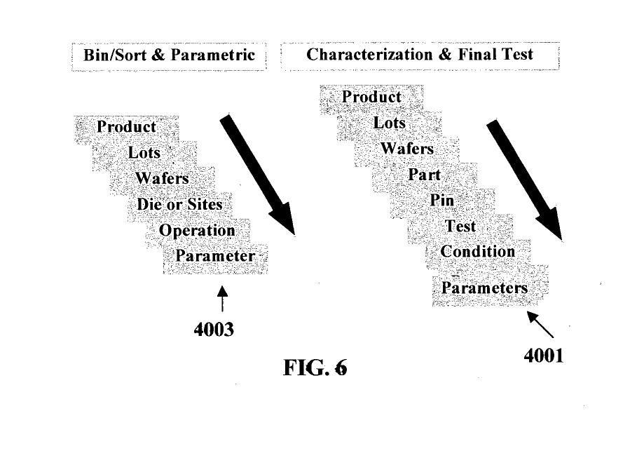

FIG. 6 compares the data hierarchy for characterization and final test 4001 to that for bin/sort and parametric 4003.

The characterization module provides analysis by device pin including pin failure Pareto charts, boxplots, histograms, and pin comparison boxplots. These reports are derived from their counterparts in the bin/sort and parametric modules.

The characterization module provides the capability to correlate test data to parametric data at the lowest level of aggregation supported by the data set. For instance, if the characterization test data contains lot-level traceability only then lot-level correlation to E-Test and Sort will only be supported. If die-level traceability is supported by a characterization dataset then correlation to lot, wafer, site, and die for E—

Validation of test limits is an important aspect of device characterization. Devices with test measurements falling outside limits can either be classified as failed or grouped with less-profitable parts. The selection of test limits is important because it impacts product yield, performance, competitive positioning, system performance, system cost, functionality, and profitability.

System 100 utilizes a characterization methodology 4001 that is shown in FIG. 6.

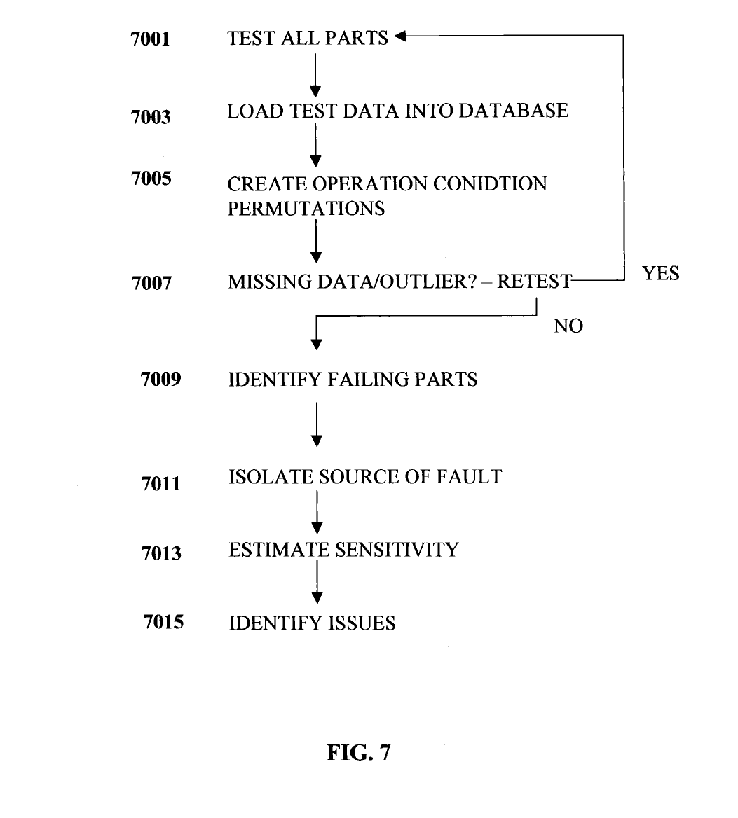

In accordance with the methodology, all the parts are tested as indicated in FIG. 7 at step 7001. In testing the parts, all parameters are measured and the test data is recorded.

The test data acquired from testing is loaded by system 100 into database 125 as indicated at step 7003. As each data set is loaded, system 100 automatically makes a determination of the data set to analyze by eliminating re-tested part measurements. For example, if a part is tested at −25 degrees C. on Monday and then again at the same temperature on Tuesday, system 100 will ensure that data obtained from database 125 is the most current data, i.e., in the preceding example Tuesday's data, since it is the most current data.

At step 7005, system 100 creates all operation condition permutations.

At step 7007, system 100 identifies any part or variable combinations for which there are missing data values and also, identifies any measurements that are out-of-bounds. System 100 flags combinations for which there is missing data as well as out-of-bounds measurements and asks the user if a retest and collection of the missing measurements should be initiated or if the system 100 should proceed.

System 100 identifies failing parameters and failing parts at step 7009, by determining for each parameter if there were any measurements that do not meet design specification and if so to determine which parts had measurements that do not meet design specifications.

System 100 is utilized to help determine why tested parameters are of specification by determining whether failures are isolated or related to manufacturing conditions, operating conditions, parts, pin groups, or pins.

System 100 utilizes a combination of methodologies to isolate sources of failures at step 7011. A “by analysis” methodology in combination with the methods described below for outlying parts, pin groups, and pins is used to determine the scope of a failure, i.e., is the failure isolated to an individual part, pin group or pin as well as the operating or manufacturing condition. Statistical Analysis of Variance and Regression are used to model the relationship between manufacturing conditions and failures.

System 100 at step 7013 creates sensitivity lists for all parameters with respect to manufacturing conditions and operating conditions. The ANOVA algorithm described below as well as linear regression is utilized to estimate a parameter's sensitivity to manufacturing and operating conditions. Both methods are reported for relationships that are statistically significant. Assumptions made by the methodology applied are validated: violations are reported to the user.

When system 100 determines that a part failed all tests, the user is asked whether the part is to be retested or pulled it out of the analysis.

System 100 determines, for each parameter that is out of spec, if there is a particular operating condition or manufacturing condition that causes the parameter to be out of specification.

By modeling the sensitivity of the parameter to different operating conditions a determination is made as to whether the parameter is highly correlated to an operating condition.

System 100 provides warnings at step 7015 as to whether there are potential issues with respect to the product. In the illustrative embodiment of the system, system 100 identifies whether there are outlying parts; outlying pin groups; outlying pins; pin group cross-overs; pin cross-overs; operating condition sensitivity; temperature sensitivity; and voltage sensitivity.

System 100 is programmed to examine data for each parameter to identify parts that behave differently from all other parts. System 100 is programmed to apply a heuristic algorithm that compares each individual part to a composite of all parts.

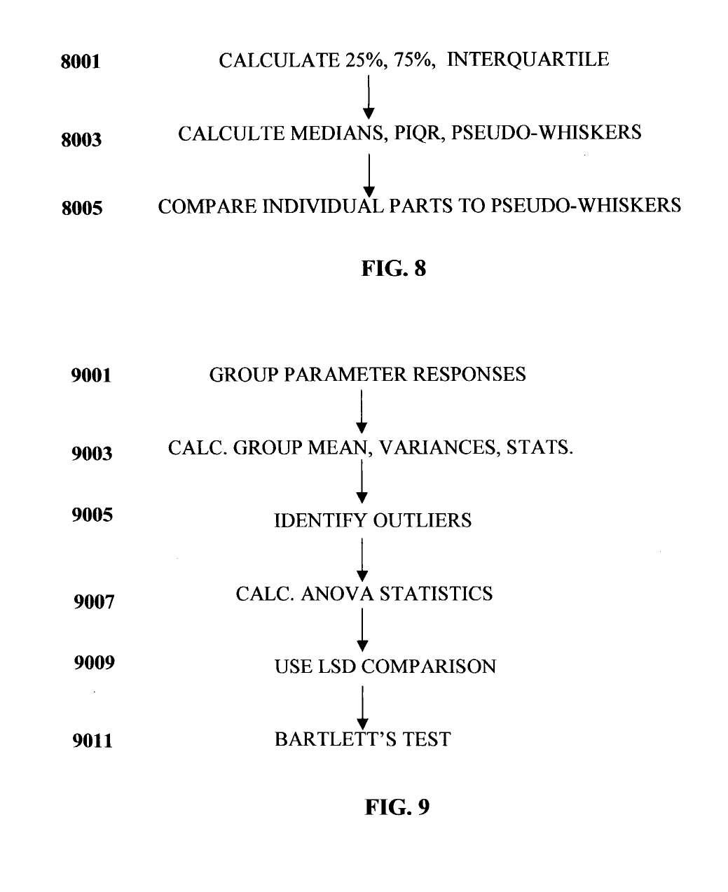

FIG. 8 illustrates a heuristic algorithm.

At step 8001, System 100 utilizes characterization data to calculate the 25^{th} percentile, 75^{th} percentile, and an inter-quartile range for all parts.

At step 8003, the median, Q1M, of the 25^{th} percentile is calculated; the median, Q3M, of the 75^{th} percentile is calculated; the difference, PIQR, between the 75^{th} and 25^{th} percentiles is calculated. First and second pseudo-whiskers, Q1M−PIQR and Q3M+PIQR, are calculated. The first and second pseudo-whiskers are analogous to whiskers of a traditional Box plot.

At step 8005, individual parts are compared to the first and second pseudo-whiskers to determine if they are outliers. A part is considered to be an outlier if any of the following conditions are true: the 25^{th} percentile of data for the part is less than Q1M−PIQR; the 75^{th} percentile of data for the part is greater than Q3M+PIQR; the IQR of data for the part is greater than a factor*PIQR; the IQR of data for the part is less than a 1/factor*PIQR.

For each parameter, system 100 identifies pin groups that behave differently across all parts by applying the heuristic algorithm of FIG. 8. Pin groups for which a parameter is not measured are ignored.

For each parameter, system 100 identifies individual pins that behave differently across all parts by applying the heuristic algorithm of FIG. 8. Pins for which a parameter is not measured are ignored.

For each parameter, system 100 determines whether parts for a specified pin group behave at given operating condition permutation than corresponding pin groups on other parts. System 100 uses sequence matching across all part and condition permutations to determine if pin groups behave the same for all parts. The sequence may be coincident, concurrent, or crossing. A warning is issued each time the sequence crosses indicating the pin group for the specific part behaves differently from other parts.

For each parameter, system 100 determines whether parts for a specified pin behave at given operating condition permutation than pin groups on other parts. System 100 applies the same sequence matching methodology described above.

For each parameter, system 100 determines whether parts are sensitive to changes in operating conditions such as temperature, frequency, and voltage. System 100 uses Analysis of Variance (ANOVA) with repeated measures (each part is measured at each condition level) which is used to test hypotheses about differences between two or more means. The basic methodology is shown in FIG. 9.

At step 9001, parameter responses for each part are grouped by system 100 into condition level groups.

At step 9003, condition-level group means, variances, and other summary statistics are calculated.

At step 9005, system 100 determines if there are any outlying values across groups and flag a warning.

At step 9007, ANOVA statistics are calculated If the condition-level group means are statistically different then system 100 use Tukey's Least Significant Difference multiple comparison method to determine which condition-levels are actually significantly different from each other as indicated at step 9009.

The ANOVA algorithm assumes that group-to-group variation is uniform. To insure the group comparisons are statistically reasonable, system 100 performs a Bartlett's test of Homogeneous Variances as indicated at step 9011. A warning is flagged if Bartlett's fails.

When the operating condition being measured is temperature; in addition to the algorithm described above, for each AC parameter, system 100 examines whether the condition sensitivity is strictly monotonic-increasing which is the expected, first-principles relationship between AC parameters and temperature. If the relationship has a change point (increasing-then-decreasing, for example) or is monotonic decreasing a warning flagged by system 100.

When the operating condition being measured is voltage; in addition to the algorithm described above, for each AC parameter, system 100 examines whether the condition sensitivity is strictly monotonic-decreasing which is the expected, first-principles relationship between AC parameters and temperature. If the relationship has a change point (increasing-then-decreasing, for example) or is monotonic decreasing a warning flagged.

The user of system 100 typically scans through all warnings and determines whether part is manufacturable and meets design specifications. If the part is not manufacturable or does not meet design specifications, a design issue must be resolved. If the part is manufacturable and meets design specifications, then the limits need to be adjusted

System 100 includes a limit optimization tool which may be used to determine optimal limits tool to compute the current yield.

In addition the tool may be used to provide “what-if” analysis to determine what would happen to yield if a parameter limit were changed or what limits are required for a specific yield setting.

The characterization processes provides a data set of test measurements. As part of the process, a sample of “known good parts” can be identified. Given a data set of test measurements for a sample of “known good parts”, a specified subset of the parts is selected that will be used to determine the product specification limits for all manufactured parts. This subset constitutes a partition of the provided data set. The minimum and maximum values of each tested parameter for the parts selected by the partitioning algorithm are then used to determine the required lower and upper specification limits, respectively.

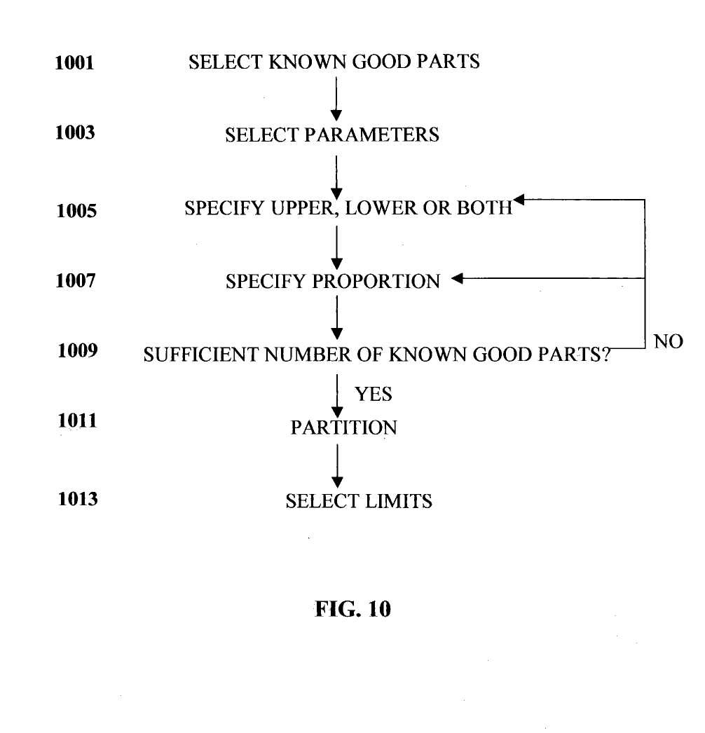

Turning to FIG. 10, the method for determining optimal specification limits is shown.

At step 1001, a set of a plurality of “known good parts” is selected by system 100 by utilizing characterization data from database 125. In order to identify a set of “known good parts”, functional testing of the products has been performed. For those products that have passed functional testing, a determination is made that the characterization test data for the products is within product design limits. Those products that have both passed functional testing and which have tested within design limits are “known good parts”.

At step 1003, the user selects parameters for which specification limits are required or desired. The number of tested parameters for each product may number in the hundreds. From all tested parameters for the products, those parameters that must be retained for purposes of determining specification limits for the product are selected. In addition any other parameters that may be deemed to be significant in selecting the subset of parts used to determine the specification limits are also selected. A default selection is to select all tested parameters. The default may be initiated by system 100.

At step 1005, limits for parameters are specified. A selection is made by the system user for each parameter as to whether lower, upper, or both specification limits are to be determined. In addition a selection may be made as to any predetermined limits that may not be varied.

At step 1007 the number of products from the sample that will actually be used to determine the specification limits is selected. This number is most conveniently specified as a ratio, or proportion, of the total part sample size. The user may select the proportion.

In any sample of “known good parts”, some parts are better than others. Some parts will have test measurement values for one or more parameters that are close to the design limits used during testing. Some parts will exhibit much greater variability in the range of measurements when more than a single measurement is taken for a given parameter. Some parts may exhibit measurement values across multiple parameters that are consistently skewed to one extreme or the other of the total range of test values. Whatever the criteria, these are the parts that should be ignored when determining specification limits. This is done by specifying the proportion of the sample of “known good parts” to be used in limit determination. If an engineer believes (with good evidence and sound judgment) that 10-15% of the sample contains parts that are not all that “good”, then a ratio (or, proportion) of 0.8 may be a good first choice.

At step 1009 a determination is made as to whether a sufficient number of “known good parts” have minimum or maximum test measurement values that lie above or below any respective predetermined lower and upper product specification limits.

If an insufficient number of parts satisfy the required proportion, then either (a) the proportion must be reduced or (b) the predetermined specification limits must be relaxed until the target proportion can be achieved. The system of the invention provides a user prompt if there are an insufficient number of parts and allows the user to determine whether the proportion is to be reduced or the specification limits relaxed.

At step 1011 the sample of known good parts is partitioned into two subsets. One subset of the sample is to be used to determine the product specification limits and is selected to contain enough parts to meet or minimally exceed the specified proportion.

The partitioning seeks to determine a minimal subset of the sample of known good parts that are not rejected by predetermined specification limit values and which satisfy the requirements of a given partitioning algorithm in selecting the subset of preferred parts for determining the product specification limits.

Partitioning is accomplished by utilizing a partitioning algorithm to separate the part sample into “accepted” and “rejected” parts. The number of “accepted” parts must minimally meet the target ratio. In one embodiment of the invention the selected partitioning algorithm must only “accept” parts that satisfy all predetermined limits. This restriction is enforced by the partitioning algorithm only passing parts that satisfy the predetermined limits. The partitioning algorithm would then have to be told explicitly the number of parts to be “accepted”. In another embodiment of the invention, the partitioning algorithm “scores” the parts based upon the relative performance with respect to each parameter and the importance of the parameter and then sorts the parts by score. Then the first “N” number of parts necessary to achieve the target ratio is selected to constitute the subset of “accepted” parts.

Once the “accepted” parts have been selected, the limits for each parameter are determined by the minimum or maximum test measurement value, as appropriate, for that parameter across all “accepted” parts. As a result, all “accepted” parts will satisfy the specification limits determined by this process. In fact, this is a direct consequence of the process. Another consequence is that the number of parts from the sample satisfying the limits determined by this process must meet or exceed the number of parts required to meet the target ratio.

At step 1013 the limits for each parameter are selected. If a lower specification limit is to be determined, the limit is set to the minimum test measurement value from the set of all test measurement values for the subset of known good parts selected by the partitioning algorithm. If an upper specification limit is to be determined, set the limit to the maximum test measurement value from the set of all test measurement values for the subset of known good parts selected by the partitioning algorithm.

At this point, the process is complete. However, the user may now investigate alternative solutions by varying the target ratio and the predetermined limit values. The user may iteratively apply the process until a final set of specification limits has been determined. This is done by taking limits determined in one iteration and converting them to “predetermined” limits in the next iteration, possibly after relaxing or tightening the value from the previous iteration.

The system and method of the invention produces product specification limits that, when applied to the sample of known good parts, will yield at least as great a proportion of accepted parts as the proportion specified as input to the process. If the sample of known good parts is representative of the universe of all manufactured parts, then the product specification limits determined by this process will be characteristic of the product.

When partitioning a sample of known good parts to select which parts are preferred as more representative of the universe of manufactured parts, different algorithms may be used

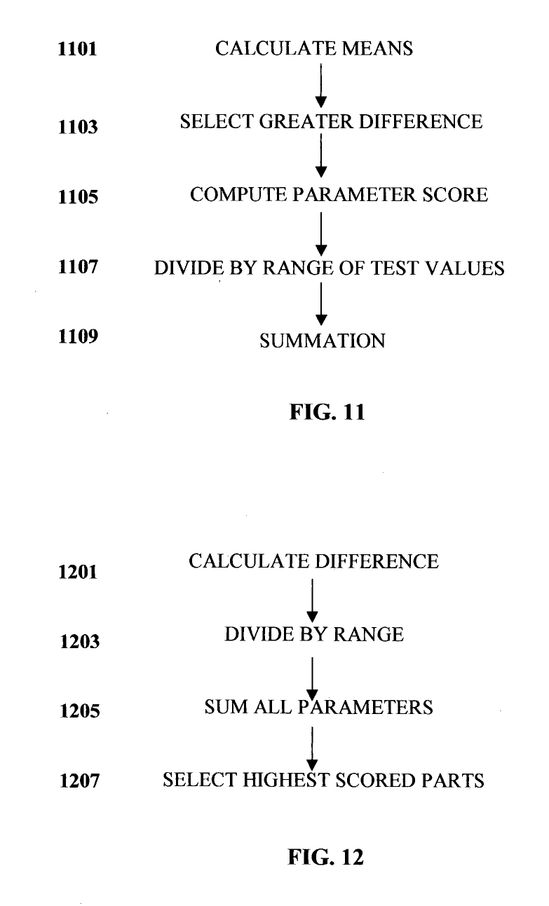

In an aggregate variability algorithm, shown in FIG. 11, a score is computed for every part. The score represents the aggregate variability of all parameters for the part. This score is a single number that can be used to sort the parts in a rank order from least aggregate variability to most. Once sorted, a sufficient number of parts to satisfy the requested proportion are selected from the parts with the lowest scores.

To compute a score for each part, the test measurement values for each parameter are examined. The mean for each parameter is selected at step 1101. For each parameter, the magnitude of variation is determined by selecting the greater of the difference of the minimum and maximum test measurement values from the mean of the part means for the parameter as shown at step 1103. A parameter score is then computed at step 1105.

For one-sided limits, the parameter score is simply the difference of the parameter minimum or maximum, as appropriate, from the mean of the parameter means by part.

For two-sided limits, the greater of the difference of the minimum or maximum test measurement value from the mean is selected. This selection is intended to produce a score that is comparable to the calculation for one-sided limits where only the difference from the mean on the side for the required limit is used. Computing a score for both limits for two-sided limits would penalize parameters with two-sided limits. Computing a score for the opposite side of a one-sided limit would impart weight to a variation in values where the variation is otherwise deemed unimportant.

Once a difference is calculated and selected, it is divided by the range of test measurement values for the parameter across all parts at step 1107. This results in a unit less value that is scaled so that it may reasonably be summed at step 1109 with values for other parameters with values of differing magnitudes and different units.

In an alternate algorithm, a margin from bound algorithm, shown in FIG. 12, a score is computed for every part that represents the aggregate margin from the appropriate bounding test measurement for all parameters for the part. This score is a single number that can be used to sort the parts in a rank order from greatest aggregate margin to least. Once sorted, a sufficient number of parts to satisfy the requested proportion are selected from the parts with the highest scores.

To compute a score for each part utilizing the margin from bound algorithm, the test measurement values for each parameter are examined. For each parameter a difference is calculated as shown in FIG. 12, step 1201. The difference calculated is determined as follows:
1. If a lower specification limit is to be determined, the difference between the minimum parameter test measurement value for the selected part and the least test measurement value for the parameter across all parts in the sample is calculated.
2. If an upper specification limit is to be determined, the difference between the maximum parameter test measurement value for the selected part and the greatest test measurement value for the parameter across all parts in the sample is calculated.
3. If both lower and upper product specification limits are to be determined, the lesser of the differences is selected.

The selected difference is divided by the range of test measurement values for the parameter across all parts as indicated at step 1203 and summed with the values so computed for all parameters tested for the given part as indicated at step 1205.

The parts with the highest scores are selected as indicated by step 1207. By selecting the parts with the highest scores computed using this method, parts whose test measurement values are farthest from the extremes are selected.

System 100 includes a “WhatIF” module 13000 shown in FIG. 5. What-if module 13000 provides a highly interactive, table-driven environment allowing the user to view and modify selections and then immediately see the effect of the changes. A user may change selections and then recalculate specification limits.

An additional capability provided by WhatIF is the ability to automatically “optimize” specification limits. The WhatIF tool automatically determines optimal specification limits to maximize the yield for the product.

WhatIF provides data selection, filtering, and scaling. The user selects and filters data from a selector. The user may select tests, specific test conditions, and specific parts. The user may select parts conditionally, e.g., only functional parts.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description It is contemplated that all such changes and additional embodiments are within the spirit and true scope of this invention as claimed below.

1. A method for determining optimal limits for products, comprising:
providing characterization data in a database for a first plurality of known good parts;
selecting a desired yield for said products;
selecting a proportion of said known good parts based upon said yield; and
utilizing a processor to obtain said characterization data for said proportion of known good parts to automatically determine specification limits for said product.

2. A method in accordance with claim 1, comprising:
partitioning said proportion of said known good parts into a first set and as second set; and
utilizing said characterization data for said first set to automatically determine said specification limits.

3. A method in accordance with claim 2, comprising
utilizing a scoring algorithm as part of said partitioning step.

4. A method in accordance with claim 2, wherein:
said partitioning step comprises utilizing an aggregate variability algorithm.

5. A method in accordance with claim 4, wherein:
said aggregate variability algorithm comprises; determining a magnitude of variation for each part parameter; dividing each magnitude of variation by a range of parameter values for all of said first plurality of parts to produce a scaled magnitude; and mathematically combining all of said scaled magnitudes for all of said parameters for a part.

6. A method in accordance with claim 5, wherein:
said magnitude variation step comprises determining the difference of the parameter minimum or maximum value and a mean of a part means for the parameter for a one-sided limit, and determining the greater difference of the parameter minimum and maximum values and a mean of the part means for the parameter for two-sided limits.

7. A method in accordance with claim 2, wherein:
said partitioning step comprises a margin from bound algorithm.

8. A method in accordance with claim 7, comprising:
calculating the difference between the minimum of a parameter value for a selected one of said plurality of parts and the least value of said corresponding parameter values for all of said plurality of parts, if a lower specification limit is to be determined; and
dividing said difference by the range of values of the corresponding parameter over all of said plurality of parts to produce a parameter score.

9. A method in accordance with claim 8, comprising:
calculating the difference between the maximum of a parameter value for a selected one of said plurality of parts and the greatest value of said corresponding parameter values for all of said plurality of parts, if an upper specification limit is to be determined; and
dividing said difference by the range of values of the corresponding parameter over all of said plurality of parts to produce a parameter score.

10. A method in accordance with claim 9, comprising:
calculating the difference between the minimum of a parameter value for a selected one of said plurality of parts and the least value of said corresponding parameter values for all of said plurality of parts;
calculating the difference between the maximum of a parameter value for said selected one of said plurality of parts and the greatest value of said corresponding parameter values for all of said plurality of parts;
selecting the lesser of the differences of the minimum and maximum parameter values if both upper and lower specification limits are to be determined; and
dividing said difference by the range of values of the corresponding parameter over all of said plurality of parts to produce a parameter score.

11. A method in accordance with claim 10, comprising:
mathematically combining all parameter scores for a part to produce a part score.

12. A method for determining specification limits for a product, comprising:
obtaining characterization data for a plurality of said product in accordance with a first algorithm;
identifying a set of known good ones of said product;
selecting a set of parameters for which specification limits are desired;
determining for each parameter of said set of parameters which of upper, lower, or upper and lower specification limits are to be obtained;
specifying a proportion of said set of known good one of said product to be used to determine product specification limits;
determining whether a sufficient number of said known good ones of said product have minimum and maximum test measurement data that are respectively above and below predetermined lower and upper product specification limits;
partitioning said sample of known good ones of said product into two subsets, a first one of said two subsets contains a sufficient number of ones of said product to at least meet said specified proportion;
said characterization data for said first one of said subsets being utilized to determine said specification limits.

13. A method in accordance with claim 1, wherein:
said product is a semiconductor device.

14. A system for use in determining specification limits for products, comprising:
a database for storing characterization data in a database for a first plurality of known good parts;
a processor operable to access said database and to operate on characterization data;
user input apparatus coupled to said processor to permit a user to select a desired yield for said products and a proportion of said known good parts based upon said yield; and
said processor being operable in accordance with a predetermined algorithm to automatically determine specification limits for said product from said characterization data for said proportion of known good parts.

15. A system in accordance with claim 14, comprising:
operating said processor to partition said proportion of said known good parts into a first set and as second set; and
said processor utilizing said characterization data for said first set to automatically determine specification limits for a product.

16. A system in accordance with claim 15, comprising
said processor utilizing a scoring algorithm as part of said partitioning step.

17. A method in accordance with claim 15, comprising:
said processor utilizing an aggregate variability algorithm to partition said known good parts.

18. A system in accordance with claim 17, wherein:
said aggregate variability algorithm comprises; determining a magnitude of variation for each part parameter; dividing each magnitude of variation by a range of parameter values for all of said first plurality of parts to produce a scaled magnitude; and mathematically combining all of said scaled magnitudes for all of said parameters for a part.

19. A system in accordance with claim 17, wherein:
said processor determines the difference of the parameter minimum or maximum value and a mean of a part means for the parameter for a one-sided limit, and determines the greater difference of the parameter minimum and maximum values and a mean of the part means for the parameter for two-sided limits.

20. A system in accordance with claim 15, wherein:
said processor utilizes a margin from bound algorithm to partition said known good parts.

21. A system in accordance with claim 20, comprising:
said processor being operated to calculate the difference between the minimum of a parameter value for a selected one of said plurality of parts and the least value of said corresponding parameter values for all of said plurality of parts, if a lower specification limit is to be determined; and
to divide said difference by the range of values of the corresponding parameter over all of said plurality of parts to produce a parameter score.

22. A system in accordance with claim 21, comprising:
said processor being operated to calculate the difference between the maximum of a parameter value for a selected one of said plurality of parts and the greatest value of said corresponding parameter values for all of said plurality of parts, if an upper specification limit is to be determined; and
to divide said difference by the range of values of the corresponding parameter over all of said plurality of parts to produce a parameter score.

23. A system in accordance with claim 22, comprising:
said processor being operated to calculate the difference between the minimum of a parameter value for a selected one of said plurality of parts and the least value of said corresponding parameter values for all of said plurality of parts;
to calculate the difference between the maximum of a parameter value for said selected one of said plurality of parts and the greatest value of said corresponding parameter values for all of said plurality of parts;
to select the lesser of the differences of the minimum and maximum parameter values if both upper and lower specification limits are to be determined; and
to divide said difference by the range of values of the corresponding parameter over all of said plurality of parts to produce a parameter score.

24. A system in accordance with claim 23, comprising:
said processor mathematically combining all parameter scores for a part to produce a part score.

25. A method for determining specification limits for a part, comprising:
collecting test data from a plurality of manufactured parts;
automatically utilizing said test data to identify known good parts;
selecting part parameters for which specification limits are to be calculated;
identify specification limit criteria;
determining a proportion of said plurality of manufactured parts;
automatically compare said plurality of parts against predetermined limits to identify a second plurality of manufactured parts;
determining whether said second plurality of manufactured parts provides said proportion;
partitioning said second plurality of manufactured parts to obtain a plurality of accepted parts;
utilizing test data from said plurality of accepted parts to determine specification limits for said part.

26. A system for determining specification limits for a part, comprising:
one or more processors operable to collect test data from a plurality of manufactured parts;
said or more processors automatically utilizing said test data to identify known good parts;
input apparatus coupled to said one or more processors to receive information selecting part parameters for which specification limits are to be calculated and to receive information determining a proportion of said plurality of manufactured parts;
said one or more processors being operated to automatically compare parameters of said plurality of parts against predetermined limits to identify a second plurality of manufactured parts and to determine whether said second plurality of manufactured parts provides said proportion;
said one or more processors automatically partitioning said second plurality of manufactured parts to identify a plurality of accepted parts; and
said one or more processors utilizing test data from said plurality of accepted parts to determine specification limits for said part.

27. A system in accordance with claim 26, wherein:
said part is a semiconductor device.

28. A method for characterization of manufactured parts, comprising:
automatically testing a plurality of parts to obtain characterization data;
automatically storing said characterization data for each of said plurality of parts in a database;
automatically identifying part parameters that do not meet design specifications;
determining if there are specific conditions that causes said part to be out of specification;
automatically modeling sensitivity of a parameter to an operating condition; and
identifying potential part issues.

29. A method in accordance with claim 28, comprising:
automatically computing a yield for said plurality of parts.

30. A method in accordance with claim 28, comprising:
utilizing an algorithm to identify outlier parts, said algorithm comparing each individual part to a composite of all other parts.

31. A method in accordance with claim 30, comprising:
calculating first and second percentiles and inter-quartile range for each parameter for each part;
calculating first and second medians for said first and second percentiles, respectively,
calculating the difference between said first and second percentiles;
calculating pseudo-whiskers;
utilizing said first and second medians, said difference and said pseudo-whiskers to identify outliers.
